(19) United States
(12) Patent Application Publication
(10) Pub. No.: US 2014/0289332 A1
(43) Pub. Date: Sep. 25, 2014

(54) SYSTEM AND METHOD FOR PREFETCHING AGGREGATE SOCIAL MEDIA METRICS USING A TIME SERIES CACHE

(71) Applicant: salesforce.com, inc., San Francisco, CA (US)

(72) Inventor: Ian Murray Frosst, Nova Scotia (CA)

(73) Assignee: salesforce.com, inc., San Francisco, CA (US)

(21) Appl. No.: 14/224,919

(22) Filed: Mar. 25, 2014

Related U.S. Application Data
(60) Provisional application No. 61/804,925, filed on Mar. 25, 2013.

(51) Int. Cl. G06Q 50/00; G06F 17/30; G06F 12/08

(52) U.S. Cl. CPC G06Q 50/01; G06F 12/0862; G06F 17/30424
USPC 709/204

(57) ABSTRACT

Methods and systems are provided for retrieving aggregate social media content metrics from a back end data store using a time series cache. The method involves populating the data store with social media content received from a plurality of social media content sources, periodically prefetching respective time series data packets from the data store, storing the prefetched time series data packets in a time series cache, retrieving, from the time series cache, a sequence of the prefetched time series data packets responsive to a user query, and presenting indicia of the sequence of the prefetched time series data packets to the user. Each time series data packet represents an aggregate of data which satisfies a topic profile for a predetermined window of time.

### CROSS-REFERENCE TO RELATED APPLICATION

This application claims the benefit of U.S. provisional patent application Ser. No. 61/804,925, filed Mar. 25, 2013, the entire content of which is incorporated by reference herein.

### TECHNICAL FIELD

Embodiments of the subject matter described herein relate generally to computer systems and applications for gathering, storing, and selectively retrieving aggregate social media content and, more particularly, to the use of an intermediate time series cache for maintaining pre-fetched time series data.

### BACKGROUND

Modern software development is evolving away from the client-server model toward network-based processing systems that provide access to data and services via the Internet or other networks. In contrast to traditional systems that host networked applications on dedicated server hardware, a “cloud” computing model allows applications to be provided over the network “as a service” supplied by an infrastructure provider. The infrastructure provider typically abstracts the underlying hardware and other resources used to deliver a customer-developed application so that the customer no longer needs to operate and support dedicated server hardware. The cloud computing model can often provide substantial cost savings to the customer over the life of the application because the customer no longer needs to provide dedicated network infrastructure, electrical and temperature controls, physical security and other logistics in support of dedicated server hardware.

Multi-tenant cloud-based architectures have been developed to improve collaboration, integration, and community-based cooperation between customer tenants without sacrificing data security. Generally speaking, multi-tenancy refers to a system where a single hardware and software platform simultaneously supports multiple user groups (also referred to as “organizations” or “tenants”) from a common data storage element (also referred to as a “multi-tenant database”). The multi-tenant design provides a number of advantages over conventional server virtualization systems. First, the multi-tenant platform operator can often make improvements to the platform based upon collective information from the entire tenant community. Additionally, because all users in the multi-tenant environment execute applications within a common processing space, it is relatively easy to grant or deny access to specific sets of data for any user within the multi-tenant platform, thereby improving collaboration and integration between applications and the data managed by the various applications. The multi-tenant architecture therefore allows convenient and cost effective sharing of similar application features between multiple sets of users.

Robust systems and applications for measuring and analyzing social media content metrics have been developed for use in the multi-tenant environment. Presently known analytics applications, such as the Radian6™ system available at www. Salesforce.com, gather metrics around blog posts, forum posts, video posts, Twitter™ feeds, Facebook™ pages, and other social media sources and points of interest. Relevant metrics include the number of times a keyword (e.g., a brand name) appears within a specified date range, the number and nature of public comments, the number of unique commenter names, number of views, comment date, and the like. Several challenges accompany the maintenance of the back end data store, and the retrieval of aggregate data from the data store. In the past the Radian6 system has employed an info cube retriever for fetching data from the cloud (data store), as well as an info cube pre-fetcher and an info cube cache for facilitating real time retrieval of aggregate data. The computational costs of that regime, however, introduce significant latency inasmuch as the Radian6 cloud monitors and aggregates thousands of data sources, translating to millions of info cubes, on a daily basis.

Systems and methods are thus needed for retrieving aggregate social media metrics which avoid the latency associated with presently known back end database interrogation protocols.

### BRIEF DESCRIPTION OF THE DRAWING FIGURES

A more complete understanding of the subject matter may be derived by referring to the detailed description and claims when considered in conjunction with the following figures, wherein like reference numbers refer to similar elements throughout the figures.

FIG. 1 is a schematic block diagram of a multi-tenant computing environment in accordance with an exemplary embodiment;

FIG. 2 is a schematic diagram of a social media data storage cloud configured to retrieve social media content analytics from a plurality of websites in accordance with an exemplary embodiment;

FIG. 3 is a schematic block diagram of a cache structure employing a time series pre-fetcher in accordance with an exemplary embodiment; and

FIG. 4 is a flow chart illustrating a method of retrieving aggregate social media content metrics from a back end data store using a time series pre-fetcher in accordance with an exemplary embodiment.

### DETAILED DESCRIPTION

Systems and methods are provided for retrieving aggregate social media content metrics from a back end data store using a time series cache. The method includes the steps of: populating the data store with social media content received from a plurality of social media content sources; periodically prefetching respective time series data packets from the data store; storing the prefetched time series data packets in a time series cache; retrieving, from the time series cache, a sequence of the prefetched time series data packets responsive to a user query; and presenting indicia of the sequence of the prefetched time series data packets to the user.

In an embodiment, presenting indicia of the sequence of the prefetched time series data packets to the user may involve performing a secondary aggregation of the data contained within the individual time series packets into a singular aggregate of the original data.

In an embodiment, each time series data packet represents an aggregate of data which satisfies a topic profile for a predetermined window of time such as, for example, a calendar day, any twenty-four hour period, or any other convenient slice of time.

In an embodiment, the topic profile may be a predefined key word search, which may be implemented in a user profile on a user dashboard.

In another embodiment, the user query may be bounded by a beginning date and an end date, and the sequence of prefetched time series data packets may have a beginning data packet corresponding to the beginning date and an end data packet corresponding to the end date. The sequence of prefetched time series data packets may also include at least one intermediate data packet corresponding to a date range between the beginning date and the end date.

In an exemplary method, populating may involve retrieving social media content received from websites, blogs, and real time feed sources.

In an embodiment, the time series cache maybe maintained using a cascading refresh scheme such as, for example, by updating more recent content at a first frequency, and updating less recent content at a second frequency which is lower than the first frequency.

The method may also involve pruning the time series cache using at least one of: refreshing prefetching time series slices for less active less frequently than for more active users; and deleting invalid time series slices from the time series cache in response to their underlying key words being changed.

In an embodiment of the method of claim 1, the step of presenting may include displaying the indicia on a display.

In various embodiments, the keyword may include a company name, product name, brand name, trademark, trade name, service mark, entity name, or the like, and the profile may be configured to identify at least one of: a keyword trending; and a keyword sentiment.

In an embodiment, periodically prefetching respective time series data packets from the data store may involve predictively prefetching time series data packets for a unique user based on the unique user's prior query history.

The methods described herein may be implemented using computer code embodied in a non-transitory computer readable medium.

A system is also provided for facilitating the retrieval of aggregate social media metrics. The system includes: a back end data store populated with social media content received from a plurality of social media content sources; a time series prefetcher configured to periodically prefetch respective time series data packets from the back end data store; a time series cache for storing the prefetched time series data packets; a data retriever module for retrieving a sequence of the prefetched time series data packets from the time series cache in response to a query from a user; and a display for presenting indicia of the sequence of the prefetched time series data packets to the user. In an embodiment, each time series data packet may represent an aggregate of data which satisfies a topic profile for a predetermined window of time such as, for example, in the range of about one calendar day.

In an embodiment, the topic profile includes a predefined key word search, the user query is bounded by a beginning date and an end date, and the sequence of prefetched time series data packets includes a beginning data packet corresponding to the beginning date and an end data packet corresponding to the end date.

A multitenant computing system is also provided for retrieving aggregate social media metrics for a plurality of users. The system includes: a back end data store populated with social media content received from a plurality of social media content sources; a time series prefetcher configured to periodically prefetch respective time series data packets from the back end data store for each of the plurality of users; a time series cache for storing the prefetched time series data packets; and a data retriever module for retrieving a sequence of the prefetched time series data packets from the time series cache in response to a query from one of the plurality of users. In an embodiment each time series data packet corresponds to an aggregate of data which satisfies a topic profile associated with one of the plurality of users for a predetermined window of time in the range of about 24 hours.

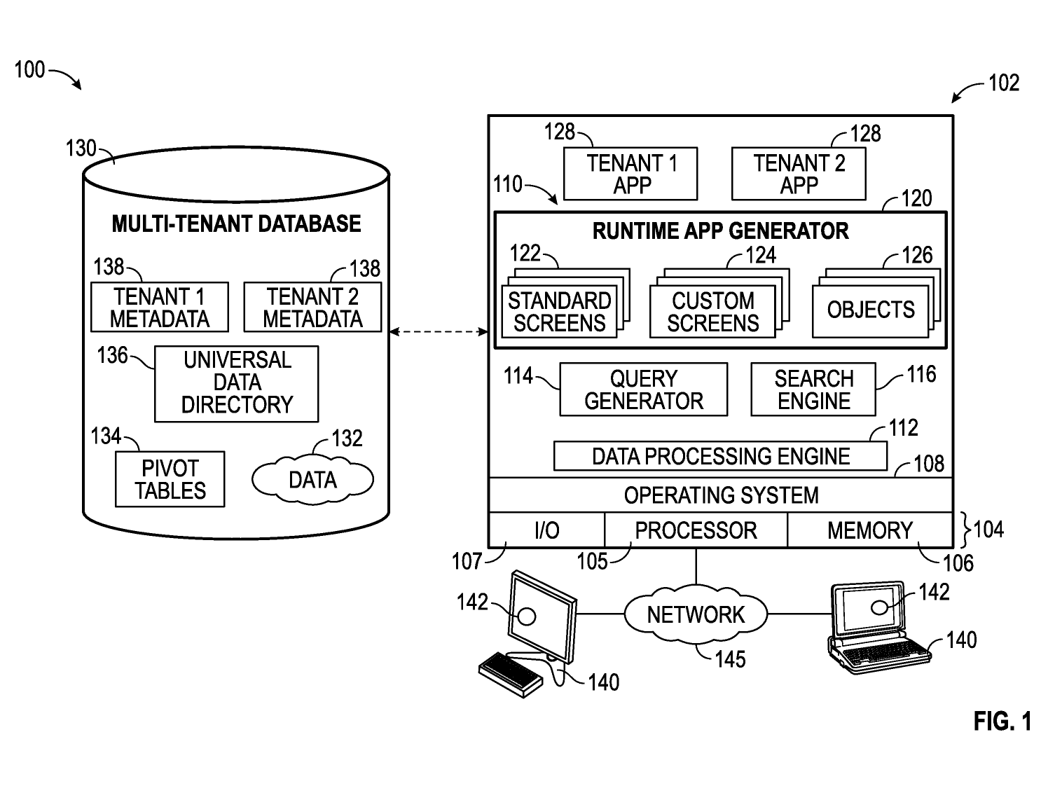

Turning now to FIG. 1, an exemplary multi-tenant system 100 includes a server 102 that dynamically creates and supports virtual applications 128 based upon data 132 from a database 130 that may be shared between multiple tenants, referred to herein as a multi-tenant database. Data and services generated by the virtual applications 128 are provided via a network 145 to any number of client devices 140, as desired. Each virtual application 128 is suitably generated at run-time (or on-demand) using a common application platform 110 that securely provides access to the data 132 in the database 130 for each of the various tenants subscribing to the multi-tenant system 100. In accordance with one non-limiting example, the multi-tenant system 100 is implemented in the form of an on-demand multi-tenant customer relationship management (CRM) system that can support any number of authenticated users of multiple tenants.

As used herein, a “tenant” or an “organization” should be understood as referring to a group of one or more users that shares access to common subset of the data within the multi-tenant database 130. In this regard, each tenant includes one or more users associated with, assigned to, or otherwise belonging to that respective tenant. Stated another way, each respective user within the multi-tenant system 100 is associated with, assigned to, or otherwise belongs to a particular one of the plurality of tenants supported by the multi-tenant system 100. Tenants may represent companies, corporate departments, business or legal organizations, and/or any other entities that maintain data for particular sets of users (such as their respective customers) within the multi-tenant system 100. Although multiple tenants may share access to the server 102 and the database 130, the particular data and services provided from the server 102 to each tenant can be securely isolated from those provided to other tenants. The multi-tenant architecture therefore allows different sets of users to share functionality and hardware resources without necessarily sharing any of the data 132 belonging to or otherwise associated with other tenants.

The Radian6 Platform presents a system in which singular representations of data (e.g., the social media information retrieved from a plurality of sources) is either stored as a singular instance available to all tenants, based upon whether their queries match, or protected and accessible only to a single tenant, based upon whether the data is unique to that tenant (for example, if it was pulled from a private Twitter or Facebook account).

The multi-tenant database 130 may be a repository or other data storage system capable of storing and managing the data 132 associated with any number of tenants. The database 130 may be implemented using conventional database server hardware. In various embodiments, the database 130 shares processing hardware 104 with the server 102. In other embodiments, the database 130 is implemented using separate physical and/or virtual database server hardware that communicates with the server 102 to perform the various functions described herein. In an exemplary embodiment, the database 130 includes a database management system or other equivalent software capable of determining an optimal query plan for retrieving and providing a particular subset of the data 132 to an instance of virtual application 128 in response to a query initiated or otherwise provided by a virtual application 128, as described in greater detail below. The multi-tenant database 130 may alternatively be referred to herein as an on-demand database, in that the multi-tenant database 130 provides (or is available to provide) data at run-time to on-demand virtual applications 128 generated by the application platform 110, as described in greater detail below.

In practice, the data 132 may be organized and formatted in any manner to support the application platform 110. In various embodiments, the data 132 is suitably organized into a relatively small number of large data tables to maintain a semi-amorphous “heap”-type format. The data 132 can then be organized as needed for a particular virtual application 128. In various embodiments, conventional data relationships are established using any number of pivot tables 134 that establish indexing, uniqueness, relationships between entities, and/or other aspects of conventional database organization as desired. Further data manipulation and report formatting is generally performed at run-time using a variety of metadata constructs. Metadata within a universal data directory (UDD) 136, for example, can be used to describe any number of forms, reports, workflows, user access privileges, business logic and other constructs that are common to multiple tenants. Tenant-specific formatting, functions and other constructs may be maintained as tenant-specific metadata 138 for each tenant, as desired. Rather than forcing the data 132 into an inflexible global structure that is common to all tenants and applications, the database 130 is organized to be relatively amorphous, with the pivot tables 134 and the metadata 138 providing additional structure on an as-needed basis. To that end, the application platform 110 suitably uses the pivot tables 134 and/or the metadata 138 to generate “virtual” components of the virtual applications 128 to logically obtain, process, and present the relatively amorphous data 132 from the database 130.

The server 102 may be implemented using one or more actual and/or virtual computing systems that collectively provide the dynamic application platform 110 for generating the virtual applications 128. For example, the server 102 may be implemented using a cluster of actual and/or virtual servers operating in conjunction with each other, typically in association with conventional network communications, cluster management, load balancing and other features as appropriate. The server 102 operates with any sort of conventional processing hardware 104, such as a processor 105, memory 106, input/output features 107 and the like. The input/output features 107 generally represent the interface(s) to networks (e.g., to the network 145, or any other local area, wide area or other network), mass storage, display devices, data entry devices and/or the like. The processor 105 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 106 represents any non-transitory short or long term storage or other computer-readable media capable of storing programming instructions for execution on the processor 105, including any sort of random access memory (RAM), read only memory (ROM), flash memory, magnetic or optical mass storage, and/or the like. The computer-executable programming instructions, when read and executed by the server 102 and/or processor 105, cause the server 102 and/or processor 105 to create, generate, or otherwise facilitate the application platform 110 and/or virtual applications 128 and perform one or more additional tasks, operations, functions, and/or processes described herein. It should be noted that the memory 106 represents one suitable implementation of such computer-readable media, and alternatively or additionally, the server 102 could receive and cooperate with external computer-readable media that is realized as a portable or mobile component or platform, e.g., a portable hard drive, a USB flash drive, an optical disc, or the like.

The application platform 110 is any sort of software application or other data processing engine that generates the virtual applications 128 that provide data and/or services to the client devices 140. In a typical embodiment, the application platform 110 gains access to processing resources, communications interfaces and other features of the processing hardware 104 using any sort of conventional or proprietary operating system 108. The virtual applications 128 are typically generated at run-time in response to input received from the client devices 140. For the illustrated embodiment, the application platform 110 includes a bulk data processing engine 112, a query generator 114, a search engine 116 that provides text indexing and other search functionality, and a runtime application generator 120. Each of these features may be implemented as a separate process or other module, and many equivalent embodiments could include different and/or additional features, components or other modules as desired.

The runtime application generator 120 dynamically builds and executes the virtual applications 128 in response to specific requests received from the client devices 140. The virtual applications 128 are typically constructed in accordance with the tenant-specific metadata 138, which describes the particular tables, reports, interfaces and/or other features of the particular application 128. In various embodiments, each virtual application 128 generates dynamic web content that can be served to a browser or other client program 142 associated with its client device 140, as appropriate.

The runtime application generator 120 suitably interacts with the query generator 114 to efficiently obtain multi-tenant data 132 from the database 130 as needed in response to input queries initiated or otherwise provided by users of the client devices 140. In a typical embodiment, the query generator 114 considers the identity of the user requesting a particular function (along with the user's associated tenant), and then builds and executes queries to the database 130 using system-wide metadata 136, tenant specific metadata 138, pivot tables 134, and/or any other available resources. The query generator 114 in this example therefore maintains security of the common database 130 by ensuring that queries are consistent with access privileges granted to the user and/or tenant that initiated the request.

With continued reference to FIG. 1, the data processing engine 112 performs bulk processing operations on the data 132 such as uploads or downloads, updates, online transaction processing, and/or the like. In many embodiments, less urgent bulk processing of the data 132 can be scheduled to occur as processing resources become available, thereby giving priority to more urgent data processing by the query generator 114, the search engine 116, the virtual applications 128, etc.

In exemplary embodiments, the application platform 110 is utilized to create and/or generate data-driven virtual applications 128 for the tenants that they support. Such virtual applications 128 may make use of interface features such as custom (or tenant-specific) screens 124, standard (or universal) screens 122 or the like. Any number of custom and/or standard objects 126 may also be available for integration into tenant-developed virtual applications 128. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system. The data 132 associated with each virtual application 128 is provided to the database 130, as appropriate, and stored until it is requested or is otherwise needed, along with the metadata 138 that describes the particular features (e.g., reports, tables, functions, objects, fields, formulas, code, etc.) of that particular virtual application 128. For example, a virtual application 128 may include a number of objects 126 accessible to a tenant, wherein for each object 126 accessible to the tenant, information pertaining to its object type along with values for various fields associated with that respective object type are maintained as metadata 138 in the database 130. In this regard, the object type defines the structure (e.g., the formatting, functions and other constructs) of each respective object 126 and the various fields associated therewith.

Still referring to FIG. 1, the data and services provided by the server 102 can be retrieved using any sort of personal computer, mobile telephone, tablet or other network-enabled client device 140 on the network 145. In an exemplary embodiment, the client device 140 includes a display device, such as a monitor, screen, or another conventional electronic display capable of graphically presenting data and/or information retrieved from the multi-tenant database 130, as described in greater detail below.

Typically, the user operates a conventional browser application or other client program 142 executed by the client device 140 to contact the server 102 via the network 145 using a networking protocol, such as the hypertext transport protocol (HTTP) or the like. The user typically authenticates his or her identity to the server 102 to obtain a session identifier (“SessionID”) that identifies the user in subsequent communications with the server 102. When the identified user requests access to a virtual application 128, the runtime application generator 120 suitably creates the application at run time based upon the metadata 138, as appropriate.

As noted above, the virtual application 128 may contain Java, ActiveX, or other content that can be presented using conventional client software running on the client device 140; other embodiments may simply provide dynamic web or other content that can be presented and viewed by the user, as desired. As described in greater detail below, the query generator 114 suitably obtains the requested subsets of data 132 from the database 130 as needed to populate the tables, reports or other features of the particular virtual application 128.

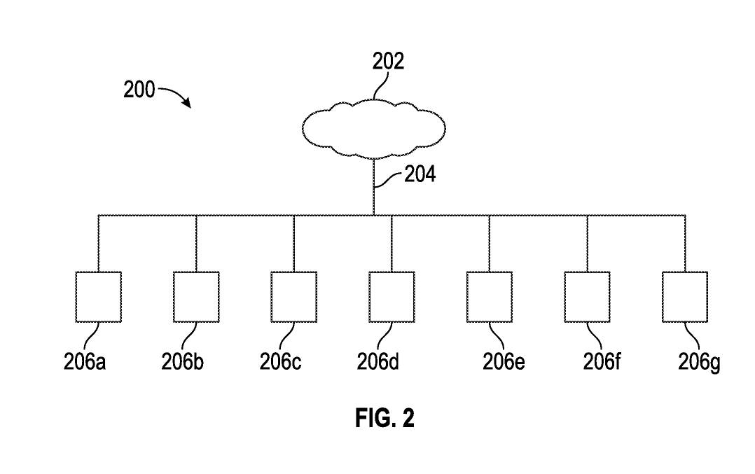

Referring now to FIG. 2, a system 200 for collecting social media content analytics includes a back end data store (computing cloud) 202 configured to retrieve metrics from a plurality of sources 206 including websites, blogs, feeds, and other delayed and/or real time sources in accordance with an exemplary embodiment. Cloud 202 may be of the type described above in conjunction with FIG. 1, and may be configured to access any number of sources 206(a)-206(g) over an Internet connection 204. The sources 206 may be any type of site from which data is monitored, retrieved, or collected. Exemplary sites may include news sites, blog sites, social media, and entertainment venues such as, for example, the Wall Street Journal (www.wsj.com), the New York Times (www.nytimes.com), the Huffington Post (www.huffingtonpost.com), and You Tube (www.youtube.com).

Robust systems currently exist for retrieving social media analytics and metrics from these websites, such as the Radian6™ product available from SalesForce.com inc. at www.radian6.com.

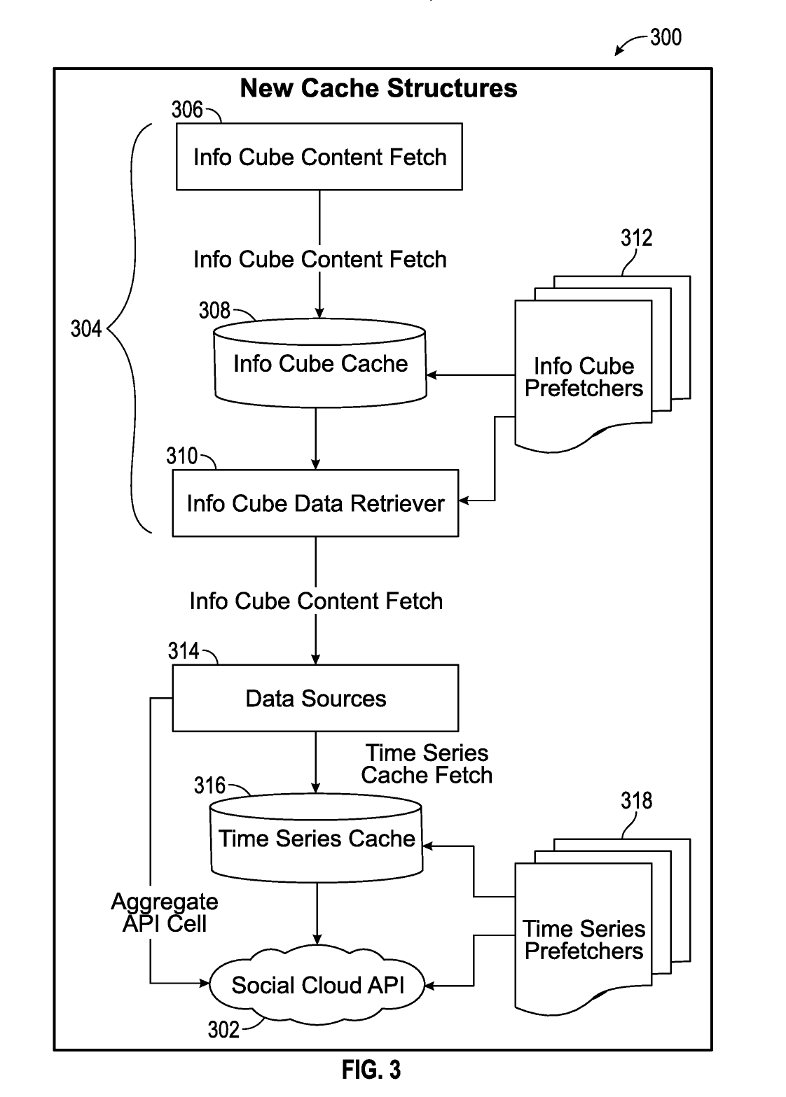

FIG. 3 is a schematic block diagram of a system 300 for facilitating the retrieval of aggregate social media metrics. The system 300 includes a back end data store 302 populated with social media content received from a plurality of social media content sources as discussed above in connection with FIG. 2. In various embodiments, the data retrieval system involves the use of “info cubes”, namely, a chunk of data presentable to a user, such as an aggregate volume of a topic profile or an overall sentiment of a topic profile based on a selected date range (e.g., trending). Thus, the system 300 may also include an info cube retrieval system 304 having an info cube content fetcher 306, an info cube cache 308, a data retriever 310, and an info cube prefetcher 312.

More particularly, the content fetcher 306 interfaces with a plurality of users, user dash boards, and the like associated with the multitenant database system described above in conjunction with FIG. 1. Specifically, user search queries may be executed by the content fetcher 306, with the assistance of the info cube prefetcher 312 and info cube cache 308, which together function as a conventional data prefetcher. If the data responsive to a search query is currently available in the info cube cache 308, the responsive data is returned to the user in the form of a response. If, on the other hand, the information responsive to a query is not currently available in the info cube cache 308, the system 300 invokes the data sources module 314.

More particularly and with continued reference to FIG. 3, the system 300 further includes a time series prefetcher 318 and a time series cache 316. During steady state operation, the time series prefetcher 316 periodically fetches data from the cloud 302, for example in a predictive manner based on prior search history. When a user query arrives at the data sources module, the system 300 first attempts to respond to the query from the time series cache 316. If the data responsive to the request is not available in the time series cache 316, the data source module interrogates the cloud 302 directly. The system 300 may also include a display (not shown) for presenting the query results to the user.

In an embodiment, each time series data packet represents an aggregate of data which satisfies a topic profile for a predetermined window of time. In a preferred embodiment, the time series data packets comprise one day's worth of data.

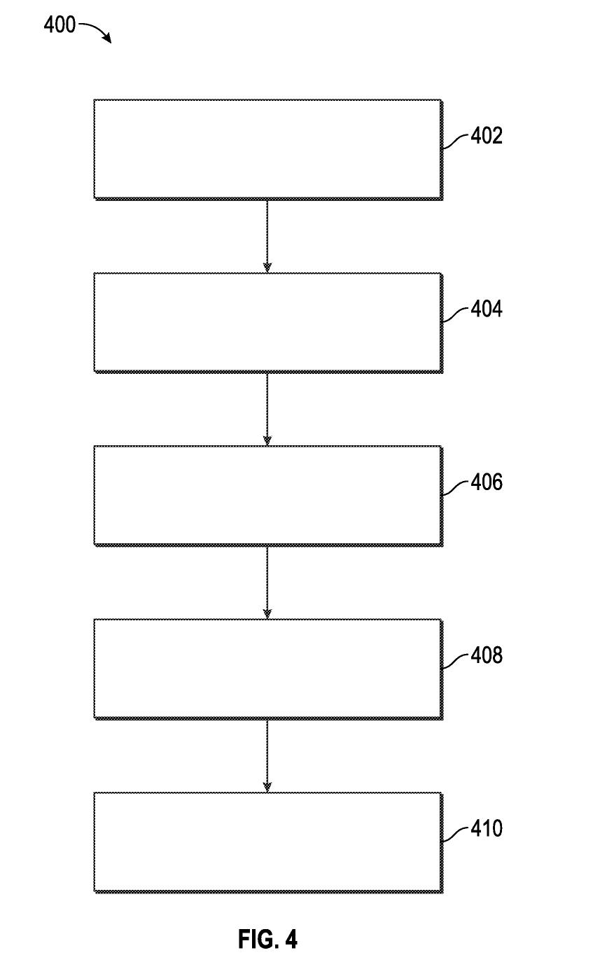

Referring now to FIG. 4, a method 400 for retrieving aggregate social media content metrics from a back end data store using a time series cache involves populating (task 402) the data store with social media content received from a plurality of social media content sources; periodically prefetching (task 404) respective time series data packets from the data store; storing (task 406) the prefetched time series data packets in a time series cache; retrieving (task 408), from the time series cache, a sequence of the prefetched time series data packets responsive to a user query; and presenting (task 410) indicia of the sequence of the prefetched time series data packets to the user.

In order to avoid unbounded growth of the time series cache, the cache 316 may be pruned from time to time, for example, by deleting invalid data (such as when a standing query changes its key words). In addition, a cascading refresh rate may be used to populate the time series cache 316, whereby more recent content is updated more frequently than older data. In this regard, those skilled in the art will appreciate that certain data, such as articles, may be updated on a weekly basis, whereas other sources such as Facebook™ may be updated daily. Real time data sources, such as Twitter™, may be updated in real time.

The foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary” means “serving as an example, instance, or illustration.” Any implementation described herein as exemplary is not necessarily to be construed as preferred or advantageous over other implementations, and the exemplary embodiments described herein are not intended to limit the scope or applicability of the subject matter in any way.

For the sake of brevity, conventional techniques related to computer programming, computer networking, database querying, database statistics, query plan generation, XML and other functional aspects of the systems (and the individual operating components of the systems) may not be described in detail herein. In addition, those skilled in the art will appreciate that embodiments may be practiced in conjunction with any number of system and/or network architectures, data transmission protocols, and device configurations, and that the system described herein is merely one suitable example. Furthermore, certain terminology may be used herein for the purpose of reference only, and thus is not intended to be limiting. For example, the terms “first”, “second” and other such numerical terms do not imply a sequence or order unless clearly indicated by the context.

Embodiments of the subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In this regard, it should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In this regard, the subject matter described herein can be implemented in the context of any computer-implemented system and/or in connection with two or more separate and distinct computer-implemented systems that cooperate and communicate with one another. That said, in exemplary embodiments, the subject matter described herein is implemented in conjunction with a virtual customer relationship management (CRM) application in a multi-tenant environment.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application. Accordingly, details of the exemplary embodiments or other limitations described above should not be read into the claims absent a clear intention to the contrary.

What is claimed is:

1. A method of retrieving aggregate social media content metrics from a back end data store using a time series cache, comprising:
populating the data store with social media content received from a plurality of social media content sources;
periodically prefetching respective time series data packets from the data store;
storing the prefetched time series data packets in a time series cache;
retrieving, from the time series cache, a sequence of the prefetched time series data packets responsive to a user query; and
presenting indicia of the sequence of the prefetched time series data packets to the user;
wherein each time series data packet comprises an aggregate of data which satisfies a topic profile for a predetermined window of time.

2. The method of claim 1, wherein the predetermined window of time comprises one calendar day.

3. The method of claim 1, wherein the predetermined window of time comprised twenty-four hours.

4. The method of claim 1, wherein the topic profile comprises a predefined key word search.

5. The method of claim 4, wherein the key word search is implemented in a user profile on a user dashboard.

6. The method of claim 1, wherein the user query is bounded by a beginning date and an end date, and wherein the sequence of prefetched time series data packets comprises a beginning data packet corresponding to the beginning date and an end data packet corresponding to the end date.

7. The method of claim 6, wherein the sequence of prefetched time series data packets further comprises at least one intermediate data packet corresponding to a date range between the beginning date and the end date.

8. The method of claim 1, wherein populating comprises retrieving social media content received from websites, blogs, and real time feed sources.

9. The method of claim 1, further comprising:
maintaining the time series cache using a cascading refresh scheme.

10. The method of claim 9, wherein the cascading refresh scheme comprises updating more recent content at a first frequency, and updating less recent content at a second frequency which is lower than the first frequency.

11. The method of claim 10, further comprising pruning the time series cache using at least one of:
refreshing prefetching time series slices for less active less frequently than for more active users; and
deleting invalid time series slices from the time series cache in response to their underlying key words being changed.

12. The method of claim 1, wherein presenting comprises displaying the indicia on a display.

13. The method of claim 4, wherein the keyword comprises one of a company name, product name, brand name, trademark, trade name, service mark, and entity name.

14. The method of claim 5, wherein the profile is configured to identify at least one of:
a keyword trending; and
a keyword sentiment.

15. The method of claim 1, wherein periodically prefetching respective time series data packets from the data store comprises predictively prefetching time series data packets for a unique user based on the unique user's prior query history.

16. The method of claim 1, wherein the method is implemented using computer code embodied in a non-transitory computer readable medium

17. A system for facilitating the retrieval of aggregate social media metrics, the system comprising:
a back end data store populated with social media content received from a plurality of social media content sources;
a time series prefetcher configured to periodically prefetch respective time series data packets from the back end data store;
a time series cache for storing the prefetched time series data packets;
a data retriever module for retrieving a sequence of the prefetched time series data packets from the time series cache in response to a query from a user; and
a display for presenting indicia of the sequence of the prefetched time series data packets to the user;
wherein each time series data packet comprises an aggregate of data which satisfies a topic profile for a predetermined window of time.

18. The system of claim 17, wherein the predetermined window of time is in the range of about one calendar day.

19. The system of claim 17, wherein the topic profile comprises a predefined key word search, and further wherein the user query is bounded by a beginning date and an end date, and the sequence of prefetched time series data packets comprises a beginning data packet corresponding to the beginning date and an end data packet corresponding to the end date.

20. A multitenant computing system for retrieving aggregate social media metrics for a plurality of users, the system comprising:
a back end data store populated with social media content received from a plurality of social media content sources;
a time series prefetcher configured to periodically prefetch respective time series data packets from the back end data store for each of the plurality of users;
a time series cache for storing the prefetched time series data packets; and
a data retriever module for retrieving a sequence of the prefetched time series data packets from the time series cache in response to a query from one of the plurality of users;
wherein each time series data packet comprises an aggregate of data which satisfies a topic profile associated with one of the plurality of users for a predetermined window of time in the range of about 24 hours.
